(19) United States
(12) Patent Application Publication
(10) Pub. No.: US 2009/0221422 A1
(43) Pub. Date: Sep. 3, 2009

(54) HAND-HELD LASER DEVICE WITH A LASER SOURCE AND AN INTERNAL POWER SUPPLY

(75) Inventor: David Miller, Widnes (GB)

Correspondence Address: Levenfeld Pearlstein, LLC;Intellectual Property Department, 2 North LaSalle, Suite 1300, Chicago, IL, 60602, US

(73) Assignee: DATALASE, LTD., Widnes (GB)

(21) Appl. No.: 12/093,127

(22) PCT Filed: Nov. 8, 2006
(86) PCT No.: PCT/GB06/04177

§ 371 Date: Sep. 22, 2008

(30) Foreign Application Priority Data
Nov. 10, 2005 (GB) 0522974.5

(51) Int. Cl. B41M 5/24

(52) U.S. Cl. 503/201

(57) ABSTRACT

The present application relates to a hand held device (1) for emitting a laser beam (8), the device comprising a laser source (2) having a power rating of at least 10 mW, an internal power supply (3) adapted to supply power to the laser source, and at least one optical element (7) for manipulating, in use, a beam (3) produced by the laser source.

### FIELD OF THE INVENTION

This invention relates to a hand-held device for emitting a laser beam. In particular, this invention relates to a compact, high power laser device having an internal power supply.

### BACKGROUND TO THE INVENTION

Lasers have been widely used for marking of substrates, typically by ablation but also by causing material, that can absorb laser energy, to char or to change colour. WO97/47397 discloses a method and apparatus for marking a product with identification indicia. A coating layer is formed on the substrate to be marked. The coating layer contains an additive that is darkenable under the action of a CO₂ laser beam. CO₂ lasers have typically been used for this purpose due to their long operating lives of at least 10,000 operating hours. The coating is darkenable upon irradiation with focused energy of the laser source.

Lasers have also been widely used to achieve welding by use of curable formulations, typically in the near infrared region using, for example, carbon black. Other curing applications are also known, for example in the curing of adhesives or sealants.

Whilst many large scale marking/printing and curing applications are known using laser energy sources, these generally involve large, expensive apparatus having a long setup time and high power consumption.

### SUMMARY OF THE INVENTION

In accordance with a first aspect, the present invention is a hand-held device for emitting a laser beam, the device comprising a laser source having a power rating of at least 10 mW, an internal power supply adapted to supply power to the power source, and at least one optical element for manipulating, in use, a beam produced by the laser source.

The device of the present invention is advantageous in that it is small, easily manipulable and self contained, yet emits a laser beam of sufficient energy for use in small to very small scale printing and/or curing applications of the order of centimetres or less.

In accordance with a second aspect, the present invention is a method of ink-less printing comprising providing a substrate including an additive susceptible to changing colour when energized by a laser, providing a hand-held device in accordance with the first aspect of the present invention, positioning the hand-held device over the substrate, and energizing the laser source to cause the device to emit a laser beam such that at least one desired point on the substrate is energized by the beam thus causing the additive to change colour at said point.

In accordance with a third aspect, the present invention is a method of curing a substrate comprising providing a substrate to be cured when energized by a laser, providing a hand-held device in accordance with the first aspect of the present invention, positioning the hand-held device over the substrate, and energizing the laser source to cause the device to emit a laser beam such that the substrate is energized by the beam thus causing curing of the substrate.

### DESCRIPTION OF THE INVENTION

The hand-held device in accordance with the first aspect of the present invention may have an infrared, visible or UV laser source. The device has at least one optical element which may be a focusing lens, preferably an auto focus lens, and/or a collimating lens. The optical element may further be a mask through which at least some of the laser beam passes before leaving the device. The mask may be provided in addition to other optical elements. A latent image formed on the mask may be fixed or may be variable, for example a liquid crystal optical shutter array, which may be pre-programmed or actively controlled. The internal power supply is preferably a battery which may be removable and may be rechargeable.

The laser source may be a laser diode, a fibre-coupled laser diode, a laser array, or a diode-pumped solid-state laser. The power rating of the laser source may be between 10 to 20 mW, 20 to 30 mW, 30 to 40 mW, 40 to 50 mW, 50 to 100 mW, 100 to 200 mW, 200 to 500 mW, 500 mW to 1 W, 1 to 10 W, 10 to 20 W, 20 to 50 W, 50 to 100 W, or any combination of these ranges. The power rating of the laser source may be selected depending on the application and its power output may be fixed, or may be actively or passively controlled within that rating. The hand-held device preferably has a button which, when depressed by a user, energizes the laser source. Once energized, the laser source remains energized either until the button, or other user input means, is released, or otherwise disengaged, or the device may be adapted such that the laser source remains energized for a predetermined period before being automatically de-energized.

In a preferred embodiment, the device further comprises a photo-receiver which is preferably a photo-diode which may have an optical filter disposed upstream of the photo-receiver in a direction of received light. The optical filter is preferably a narrow bandwidth filter.

The device may be in the form of a pen, particularly for use in laser “writing” applications, or may have any other suitable ergonomic shape depending on the application.

### DESCRIPTION OF DRAWINGS

The embodiments of the present invention will now be described with reference to the accompanying drawings in which:

FIG. 1 is a schematic representation of the hand-held device in accordance with an embodiment of the present invention;

FIG. 2 is a schematic representation of a hand-held device in accordance with another embodiment of the present invention;

FIG. 3 is a schematic representation of the optical path of the laser beam in a first arrangement; and

FIG. 4 is a schematic representation of the path of the laser beam in accordance with an alternative arrangement.

### DETAILED DESCRIPTION

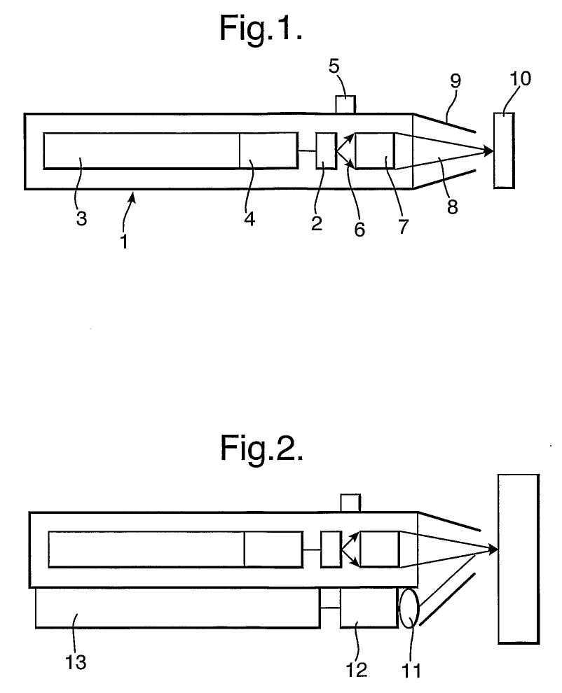

Turning first to FIG. 1 the hand-held device comprises a housing 1 containing a laser diode 2 having a power rating of 10 mW. The laser diode 2 is electrically connected to a battery 3 via a control electronics module 4. The laser diode 2 is activated in response to a user depressing button 5 which is connected to the control electronics module 4. Upon depression of button 5, power is supplied to the laser diode 2. The laser diode 2 emits a laser beam 3 having a wide divergence angle. The footprint of the laser beam 3 is generally oval-shaped. The laser beam 6 enters optical element 7 which manipulates the laser beam 6 such that the laser beam 8 exiting the optical element 4 has a desired focal length, homogeneity, and spot size. Extending from the housing 1 is a guide 9 to aid positioning of the device by the user since the guide 9 indicates the focal point of the laser emanating from the device, in use. The device must be used with regard to appropriate safety measures to ensure safe laser exposure limits are not exceeded.

The hand-held device described above is suitable for use in ink-less printing, marking and curing applications. In each of these applications the device is to be positioned such that the shielding element 9 is adjacent a substrate 10 to be printed, marked or cured. The device should be positioned such that the optical axis of the laser beam 8 is substantially perpendicular to a surface of the substrate 10 to be irradiated. The control electronics module 4 may be adapted such that upon depression of the button 5, the laser diode 2 is supplied with power from the battery 3 for a predetermined period of time. Alternatively, the control electronics module 4 may be adapted to continue to supply power from the battery 3 to the laser diode 2 until the user once again depresses the button 5. In either case, the irradiating period should be adapted such that a fluence level required by the substrate 10 to effect the appropriate marking or curing application is obtained.

The power output of the laser diode 2 may be fixed, for example at the maximum power rating of the laser diode 2, or may be fixed at a power level below that of the maximum power rating of the laser diode 2. Alternatively, the power output of the laser diode 2 may be variable and controlled by the control electronics module 4. The optical element 7 may be a collimating, focusing or auto-focusing lens or a combination of these. Element 7 may further include a mask having a latent image formed thereon. The latent image of the mask may be either fixed or variable and controlled by the control electronics module 4. The mask selectively allows passage of at least some of the laser beam 6 to pass therethrough to form laser beam 8. A suitable mask may be an LCD optical shutter array or the like. Details of such an optical shutter array are provided in applicants co-pending British Patent Application No. 0520115.7.

The hand-held device of FIG. 1 is shaped like a pen such that the device is particularly suitable for ink-less “writing” applications. In such applications, the substrate 10 includes, or has a coating which includes, an additive susceptible to changing colour when energized by a laser. Suitable additives are disclosed in applicants co-pending applications PCT/GB05/00121 and GB0418676.3. These two applications detail preferred materials for imaging at near infrared and violet/ultraviolet wavelengths, respectively, two wavelengths at which diode lasers are currently readily available. The type and concentration of the additive should be matched to the fluence level of the incident radiation and thus to the type of laser diode 2, the exposure time and the type of optical element 7. The same is true for curing applications.

FIG. 2 illustrates an alternative embodiment of the hand-held device of the present invention in which the device of FIG. 1 is supplemented by light detecting means. The light detecting means comprise a narrow band filter/collector 11, a photo-diode receiver 12 and control electronics 13. The light receiving means are suitable for use in security verification of documents, for example. The verification process comprises illuminating the substrate 10 having a coating containing materials such as fluorescers that respond to the wavelength of the laser light emitted by the hand-held device. The fluorescers emit light of a different wavelength to that emitted by the device. The light emitted by the fluorescers enters the narrow band filter/collector 11 which allows passage of only light of a particular wavelength. Light which passes through the narrow band filter/collector 11 enters the photo-diode receiver 12. Detection of light received by the photo-diode receiver 12 is performed by the control electronics 13. Using such light detecting means makes it possible to determine the presence or absence of a specific coating. This is particularly useful in retail verification of receipts, banknotes, security documents or other point of sale applications.

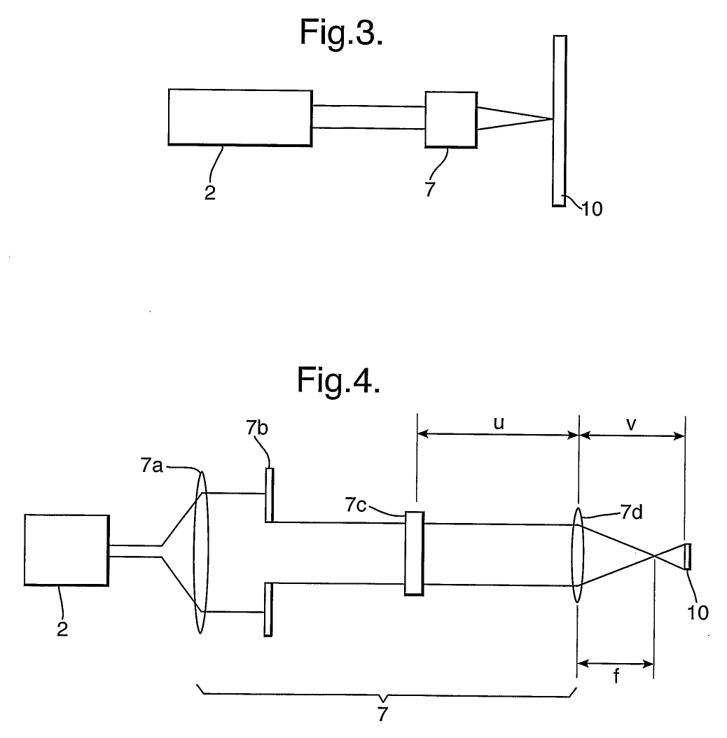

FIG. 3 illustrates the passage of laser light through the devices of FIGS. 1 and 2 in accordance with a first arrangement. The optical element 7 includes a focus lens. The focus lens may be either a fixed or automatic focusing lens. The optical elements 7 may further include a photomask. Such an arrangement is particularly suitable for use in printing a micro-dot or micro-signature image on the substrate 10. By fixing the laser beam to a near singularity, a relatively low laser beam power may be used to achieve an adequate fluence level on the surface of the substrate 10. This has particular advantages in terms of battery size and power consumption. This micro-printing has particular application in the field of security printing where the printed end product is not visible with the naked eye, or even with some low power microscopes.

By altering the focal length of the optical element 7, the size of the spot or image footprint on the surface of the substrate 10 may be increased such that the printed image increases in size. However, this will require either a higher laser diode 2 power output or an increase in exposure time for like substrates 10. In any such security printing the matching of the hand-held laser device to the substrate improves the security of the document to be printed since it can only be reproduced where a forger has access to both the substrate and the hand-held device.

The printing of micro-dots or micro-signatures has further application in the field of supply chain verification and/or inspection of branded goods. It is often desirable that any such verification is marked on the goods themselves. However, in certain applications it is desirable that this marking is not readily visible to an end user. This may be achieved by either marking the substrate such that the mark is only visible under ultraviolet or infrared light, or is so small as to be invisible to the naked eye. Marking of passports and other identification documents is also foreseen using this technique.

Another potential application of the present invention is in the field of tattoos. It is conceived that a suitable transparent coating may be applied to the skin which is subsequently irradiated using the hand-held device in accordance with the present invention to effect a colour change in order to image the tattoo. Depending on the coating formulation, a monochrome, grayscale or full multi-tonal colour image may be developed from a single exposure using the device. It is also conceived that, so long as laser safety regulations may be complied with, the hand-held device may be used to image substrates directly without the application of a suitable coating formulation.

In the field of curing applications for small scale curing it is advantageous that the formulation being cured exhibits a colour change following exposure at a predetermined fluence level. For example, the same formulation undergoing curing may change colour after a predetermined interval at a particular exposure intensity level corresponding to the same level required to effect the curing. Suitable curing substrates are many polymers and ceramics and pre-ceramics having diverse applications from cosmetic treatments to hand crafting. By altering the concentration of additives susceptible to changing colour in particular locations it becomes possible to effect a different colour change under the same fluence level to that of an adjacent point on the substrate. This is particularly useful where it is required to image a micro-signature or date stamp for the particular curing procedure. Verification of such marking may be effected using the embodiment of FIG. 2. The same technique may be used for confirming writing of optical media.

FIG. 4 shows an alternative optical arrangement for the device in which the optical element 7 is arranged in a, so-called, relay imaging setup. The optical element 7 comprises a lens 7d having a lens focal length f used to relay an image produced on an image mask 7c onto the substrate 10. The lens 7d is disposed a distance used in the image mask 7c, which distance may be greater than the lens focal length f (u is greater than f). A de-magnified image is formed on the substrate 10 at a distance v from the imaging lens 7a according to the well known formula (1/f)=((1/u)+(1/v)). The de-magnification ratio is given by (v/u).

For large de-magnifications, several relay image systems can be cascaded in series, simply using the image plane of one system to act as the virtual mask for the next system. This negates the requirement for large path lengths (de-magnification v/u). Conversely, if a single de-magnification is preferred and consequently large path links are required, the path can be conceded/folded using mirrors allowing in the compact design to be utilized.

In the system of FIG. 4, the light emitted by the laser diode 2 is expanded and clipped prior to relay image. The expanded light is focused by a lens 7a and clipped by aperture 7b. This allows a more uniform beam profile to be generated and consequently more uniform illumination of the mask 7c. This permits a more homogeneous light beam to fall incident on the mask 7c.

An alternative mode of operation could utilize the Fourier transform imaging in a focus geometry. To accomplish this the mask 7c must be replaced by a Fourier image mask of the required final image at the focus of the lens 7d instead of the image plane on the substrate 10 as per relay imaging. A simple focusing lens would then generate very detailed images in a small spot. Moreover, this also facilitates use of a relatively simple compact arrangement comprised of a single lens and Fourier image mask.

It is also envisaged that the optical element 7 could be replaced or include a holographic element or optical setup capable of generating a holographic image on the substrate 10.

It is envisaged that the battery 3 of the hand-held device may be either a rechargeable battery having a suitable connection to a charger, or a removable battery to be replaced where necessary. Although the device has been described with reference to a laser diode as the laser source, it is specifically intended that a fibre-coupled laser diode, a laser array, or a diode-pumped solid-state laser may be used instead. The power rating of the laser source, so as to be suitable for the particular applications described above, is at least 10 mW. However, it will be appreciated that a power rating of between 10 to 20 mW, 20 to 30 mW, 30 to 40 mW, 40 to 50 mW, 50 to 100 mW, 100 to 200 mW, 200 to 500 mW, 500 mW to 1 W, 1 to 10 W, 10 to 20 W, 20 to 50 W, 50 to 100 W, or any combination of these ranges may be suitable depending on the particular application.

In addition to the substrate materials described above, the following substrate materials may be suitable for use in the methods of the present invention as defined by the appending claims: metals, alloys, glasses, ceramics, plastics, fabrics, wood, paper, card, resins, rubbers, foams, composites, stone, walls and body tissue. Substrate materials for use in curing applications may, in particular, be adhesives, sealants or dental composites.

1-27. (canceled)

28. A method of inkless printing comprising:
providing a hand-held device for emitting a laser beam, the device including a laser source having a power rating of at least 10 mW, an internal power supply adapted to supply power to the laser source, and at least one optical element for manipulating, in use, a beam produced by the laser source;
providing a substrate including an additive susceptible to changing colour when energized by a laser beam;
positioning the hand-held device over the substrate; and
energizing the laser source to cause the hand-held device to emit a laser beam such that at least one desired point on the substrate is energized by the beam thus causing the additive to change colour at said point.

29. The method according to claim 28, wherein the step of providing the substrate includes the step of matching the additive, or a concentration of the additive, in the substrate to a range of fluence levels achievable with the device.

30. The method according to claim 28, wherein a grey-scale image is developed on the substrate by energizing the substrate having the additive at a plurality of different fluence levels.

31. The method according to claim 28, wherein a multi-tonal colour image is developed on the substrate by energizing the substrate having the additive at a plurality of different fluence levels.

32. The method according to claim 27, wherein a micro-dot image is developed on the substrate.

33. The method according to claim 28, wherein the substrate material is selected from metals, alloys, glasses, ceramics, plastics, fabrics, wood, paper, card, resins, rubbers, foams, composites, stone, edibles and body tissue.

34. The method according to claim 28, further comprising the step of manipulating the laser beam by the optical element.

35. The method according to claim 34, wherein the laser beam is manipulated by a focusing lens, preferably an auto-focus lens, or a collimating lens, or a photomask having a fixed or variable image formed thereon.

36. The method according to claim 28, wherein the internal power supply is a battery.

37. The method according to claim 28, wherein the laser source is a diode laser, a fibre-coupled diode laser, a laser array, or a diode-pumped solid-state laser.

38. The method according to claim 28, wherein the power rating of the laser source is between 10 to 20 mW, 20 to 30 mW, 30 to 40 mW, 40 to 50 mW, 50 to 100 mW, 100 to 200 mW, 200 to 500 mW, 500 mW to 1 W, 1 to 10 W, 10 to 20 W, 20 to 50 W, 50 to 100 W, or any combination of these ranges.

39. The method according to claim 28, wherein the energizing step is initiated by a user input.

40. The method according to claim 39, wherein the energizing step is terminated automatically or by a further user input.

41. The method according to claim 28, wherein the device is in the form of a pen.

42. The method according to claim 28, wherein the laser source is an IR, VIS or UV laser source.
